(19) United States
(12) Patent Application Publication
(10) Pub. No.: US 2007/0248098 A1
(43) Pub. Date: Oct. 25, 2007

(54) Device and method of multi-service IP-phone

(75) Inventor: Yan-Ming Chen, Taipei (TW)

Correspondence Address: BACON & THOMAS, PLLC, 625 SLATERS LANE, FOURTH FLOOR, ALEXANDRIA, VA, 22314, US

(73) Assignee: Essence Technology . Solution, Inc., Taipei County (TW)

(21) Appl. No.: 11/502,528

(22) Filed: Aug. 11, 2006

(30) Foreign Application Priority Data
Apr. 23, 2006 (TW) 095114239

(51) Int. Cl. H04L 12/56

(52) U.S. Cl. 370/395.2

(57) ABSTRACT

The present invention relates to a device, as well as a method, of a multi-service IP-phone. The device and method comprise an IP-phone, to be used for making intercom and inbound/outbound phone calls through a LAN or the Internet, and a network control unit, to be used to control the data transmitting through the network. By connecting the IP-phone with network devices and computer devices, one can not only use the IP-phone to receive and make phone calls, but also use the computer devices to access the LAN or the internet via the IP-phone, which at the same time, with its built-in network control unit, provides such functions as LAN/internet security, data security, packet filtering, bandwidth management, traffic shaping (load balance), and virtual private network (VPN).

### BACKGROUND OF THE INVENTION

1. Field of the Invention

The present invention relates to an IP-phone device and an IP-phone method, particularly it pertains to an multi-service IP-phone device and an multi-service IP-phone method cable of providing such multiple functions as LAN/internet security, data security, packet filtering, bandwidth management, traffic shaping (load balance), and virtual private network (VPN).

2. Description of the Related Art

With the advent of the Internet age, the world is closely connected in terms of information and data. The Internet has been growing at staggering speeds. With such features as instant, interactive, and borderless communication, low cost operation, and multi-media interface availability, it carries influences far wider and deeper than such traditional media as newspapers, magazines, and TVs. Internet communication service is thus spawned and structured under such Internet characteristics.

Early internet communications were generally plagued by such problems as poor sound quality, delayed response, and cumbersome operation procedures. However, with the maturing of the VOIP technology and the application of Internet/PSTN Gateway Server, new generation IP-phone s are generally characterized by their convenience, low-cost, high quality, and multi-functions.

With regard to convenience, new generation IP-phone devices, unlike early models, do not have to be used with PCs. Most models are simply operable through the aid of average a household telephone and are easy to set up and use, no particular trainings are required of the user.

As to cost, the competitive strength of the IP-phone lies mainly in its low-cost. Not only is the purchase of the required initial hardware/software affordable to most, but users will be able to make long-distance calls at the rate of local calls, getting the most value out of every dollar spent.

With regard to multi-functions, internet communication has the advantage of being able to bring sound, images, and messages together in multi-functional transmissions. The development of such technologies as I-Fax, IP-phone, Internet Answering Machine, Internet Video Phone, and Tele-Conference Equipment etc., are making the functions of communication more versatile and the world smaller.

However, all the features described above are merely the transmission of communication data, such as sounds and images through the Internet, with the possible inclusion of the extra function of i-fax to save the telephone cost of traditional fax machines. At the present, IP-phone devices that linked to computers have been on the market. Aside from having network connection ports that allow them to access a network, these IP-phone devices also have computer connection ports that allow them to link with a computer. With their built-in switching unit, these IP-phone devices can transmit their video and audio data, as well as digital data from the computer, onto the Internet. The functioning principle of the current switching unit is that the audio or video data from the IP-phone is pre-processed, for example, by compression or by A-D conversion, and then routed out through the network ports, which means that the IP-phone and the computer are connected in a serial way along the same networking connection line, in which digital data from a computer is bypassed to the network without the data packet having being processed by the switching unit. Network security functions such as guarding against virus, hacking, spamming, intrusion, monitoring, as well as packet-filtering, etc; have to be done by other devices or software.

### SUMMARY OF THE INVENTION

In view of the imperfections of conventional IP-phone devices, the inventor of the present invention has spent years researching and developing innovative IP-phone technology and eventually came up with a multi-service IP-phone device and method that can provide such extra functions as LAN/internet security, data security, packet filtering, bandwidth management, traffic shaping (load balance), and virtual private network (VPN) in addition to the core function of making intercom and inbound/outbound phone calls through a LAN or the Internet.

With Comparing to the conventional IP-phone, the multi-service IP-phone device and method of the present invention adds at least the following three additional functions under the current internet telephone infrastructure.

1. Network Security Control and Management
A. Businesses now can only exert security control over access between subnets. That is, access controls exist only between subnets and it is difficult to implement filtering or policing for computers within the same subnet. This is because the switch is multi-layered switch and requires high bandwidth, which inevitably makes it difficult to maintain security. In a corporate environment, IP-phone devices are generally set up around the computer(s) an employee uses. As the device may use the network sockets which shall be used by the computers, manufacturers have come up with IP-phone devices that could be connected to a computer. In these phones, a port, normally an RJ45 port, intended for computer connection is added, with an extra switching unit being built into it to provide link with the computer and the network serially. The innovation as made by the present invention is achieved by adding a network security unit, which can be either a single chip or a software executing by CPU in the IP-phone, or by simply replacing the switching unit with a network security unit having a built-in switching unit. Thus, all data, either those on a company's personal computers or those on an employee's notebook PCs, streaming across the corporate network can be monitored by the IP-phone in advance. The monitoring will include such processes as access control list (ACL), anti-virus, anti-hacking, anti-DoS/DdoS attack, anti-website-attack (including SQL injection attack, hidden field tampering attack, cross-site scripting attack, session hijacking attack), security level setting, anti-spam, file security control, network application access control, communication protocol control, intrusion detection and prevention, data transmission record, network application access record, and port-specific intercom and inbound/outbound security policy setting.
B. An 802.1X client for upper layer switching-circuit certificate verification mechanism is built in the IP-phone device that any working subnets within the corporate network is not allowed to access network resources without going through the IP-phone device.
C. A security policy provisioning agent is built in the IP-phone device that can be administrated by a remote central management program which assigns security level to each employee, updates virus IDs, and characterizes attacks, etc., on a daily or any other time-period basis.

2. Network Bandwidth Management Phone, or Network Quality of Service (QoS)
A. As the switching circuit is multi-layered and requires high bandwidth, it is, generally, incapable of such function as sophisticate flow control. The present invention, however, by adding a network security unit, which can be either a single chip or a software executing by CPU, in the IP-phone, or by simply replacing the switching-circuit with a network security unit having a built-in switching-circuit. Thus, when a computer, either a company PC or an employee's notebook PC, accesses the network, the IP-phone can assign a certain bandwidth to it according to a specific employee's authority, preventing unnecessary waste of network resource by employees and making the best out of corporate network resource.
B. Built in the IP-phone device is a Network Quality of Service (QoS) Policy Provisioning Agent, which can be administrated by a remote central management program that updates at any chosen time the bandwidths assigned to each employee, including such as assigned to the communication protocol and any application software.
C. Beside bandwidth management, the present invention's IP-phone can reset the QoS levels assigned to a computer's uploading packet according to application software, such as IP TOS, DiffServ DSCP, and 802.1P CoS.

3. Virtual Private Network
A. Most businesses now choose IPSec VPN, or SSL VPN as their norms in dealing with remote access attempts. Users log into a company's VPN gateway by the VPN client software executed on a remote computer and then make an access attempt at the data on the company's internal computer systems. The disadvantage of this process is that it cannot be simulated in the data link layers to initiate connection with the original working subnet, causing many remote applications fail to approach the internal host and thus unable to operate in the same way as they are in the internal working subnet. The present invention have the IP-phone built with an additional a virtual private local area network unit within, which can be either a single chip or a software executing by CPU, or simply replace the built-in switching unit with a virtual private LAN unit, making the extension line of every employee as a VPN gateway that provides the following two applications:
   a. Build a Layer-2 VPN tunnel back to one's own extension line through any extension line in the corporate internal network to access the original subnet.
   b. Build a IPSec VPN to connect to the corporate VPN Gateway through external network, and then build a Layer-2 VPN tunnel to ones own extension line to access the original subnet.
B. With a VPN Policy Provisioning Agent built in the IP-phone, each employee's VPN authorization can be updated at any time by a remote central management program.

The aim of the present invention is to provide a multi-service IP-phone that enable users to receive and make phone calls through it, while at the same time using it to access resources on LANs and the Internet, perform such functions as LAN/internet security, data security, packet filtering, bandwidth management, traffic shaping (load balance), and virtual private network (VPN).

Another aim of the present invention is to provide a network control unit to be built within the structure of an IP-phone, so that the IP-phone can perform such functions as LAN/internet security, data security, packet filtering, bandwidth management, traffic shaping (load balance), and virtual private network (VPN).

Still another aim of the present invention is to provide a multi-service IP-phone device and method that provide such functions as LAN/internet security, data security, packet filtering, bandwidth management, traffic shaping (load balance), and virtual private network (VPN).

From the above description, it is obvious that, by the unheard-of way of integrating the IP-phone with a network control unit, the present invention can effectively reduce corporate cost and save valuable office space. Furthermore, as the present invention enables the user to put the control point of network control to each personal computer, it effectively makes up for the inadequacies that are common with the prior art network control and management software/equipment.

These and other objects, features and advantages of the present invention will become more apparent from the following description and the appended claims, taken in connection with the accompanying drawings in which preferred embodiment of the present invention are shown by way of illustrative example.

### BRIEF DESCRIPTION OF THE DRAWINGS

FIG. 1 is a diagram showing the structure of conventional IP-phone device.

FIG. 2 is a diagram showing the structure of the present invention.

FIG. 3 is a diagram showing how the multi-service IP-phone device of the present invention works.

FIG. 4 is a diagram showing the structure of the network control unit of the present invention.

### DETAILED DESCRIPTION OF THE PREFERRED EMBODIMENT

Please refer to FIG. 1. FIG. 1 is a diagram showing the structure of conventional IP-phone device. A conventional IP-phone device 10 comprises: a transceiver 11, key buttons 12, a screen display 13, a network port 14, a computer port 15, and a core unit 20. Said core unit 20 is a DSP 21 (Digital Signal Processing,) made up of a CPU 22, a peripheral control unit 23, a storage device 24, and a switching unit 25. The functions of the above devices are given below:

A conventional IP-phone device 10 makes inbound or outbound calls through. On it there are such devices: a transceiver 11, for making and receiving phone calls; key buttons 12, for the user to dial phone numbers and key-in related setups; a screen display 13, for showing relevant operation messages; a network port 14, for linking with the network A; a computer port 15, and a core unit 20, which is a DSP 21 (Digital Signal Processing,) made up of a CPU 22, a peripheral control unit 23, a storage device 24, and a switching unit 25. As IP-phone devices are generally placed beside the employees' personal computers and need to use the network socket of the computer, most of current IP-phone devices have a built-in computer port 15 (usually a RJ45 port) that could be used to connect to the network port of the computer B, and, through the switching unit 25 in the core unit 20, packets from the computer port 15 are directed to the network port 14, a process called “bypass”, and then passed onto the network equipment A.

The core unit 20 is built in the IP-phone device 10 mentioned above. It comprises a digital signal processor 21 to be used to process signals, a (CPU)22 to be used to execute commands from the IP-phone device and negotiate and control behaviors, a peripheral control unit 23 to receive commands from the CPU 22 in order to control the peripherals (such as the transceiver 11) of the IP-phone device 10, a storage device 24 (such as a memory) to store data, and a switching unit 25 to direct packets from the computer port 15 to the network port 14 and then pass onto the network equipment B, as well as to transmit the audio and video data from the conventional IP-phone device through the network.

The switching unit 25 doesn't exist in all IP-phone devices. It is only built in IP-phone devices with computer ports. The main function of the switching unit 25 is to receive control signals from the CPU 22 and convert and process voice signals (and image signals as well, if the device is a video IP-phone) outgoing or incoming through the network. For the network data packets from the computer devices B or the network device A, the switching unit 25 simply affects the link between the computer port 15 and network port 14; its CPU 22 will do nothing for these packets.

All the units within the core unit 20 (DSP 21, CPU 22, peripheral control unit 23, the storage device 24, and the switching unit 25) can be either independent chips each with a single function, or several chip each with a group of functions, or even just one single chip with all functions integrated into it.

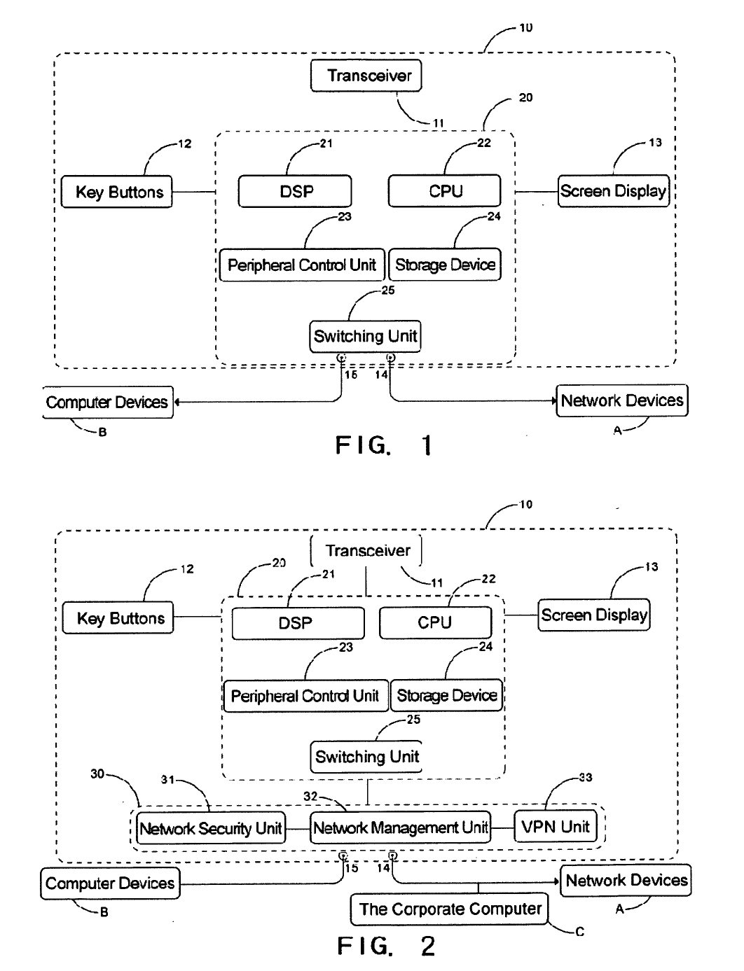

Please refer to FIG. 2. FIG. 2 is a diagram showing the structure of the present invention. The present invention differs from the conventional IP-phone devices in that it has an additional network control unit 30 built into the IP-phone. The network control unit 30, used to control the transmission of data over the LAN/Internet, comprises a network security unit 31, which is used to filter data passing through the network and monitor its security, a network management unit 32, which is used to assign, restrict, adjust, and monitor network bandwidth and flow rate, and a VPN unit 33, which is used to put encryption on data transmitted onto the internet.

With the above design and structure, by linking the network port 14 of the IP-phone device 10 with the Network devices A, and the computer port 15 of the IP-phone device 10 with the computer devices B, the user can not only use the IP-phone device 10 to receive and make phone calls, but also, through the network security unit 31 in the network control unit 30, filter network data and monitor network security. Furthermore, the network security unit 31 can be updated by a remote control program to strengthen its protection, filtering, and monitoring functions. It can also assign, restrict, adjust, and monitor network bandwidth and flow rate through the network management unit 32 in the network control unit 30. Finally, by making use of the network control unit 30 in the VPN unit 33, it allows the user, from outside the corporate and through the Internet, to access corporate resources on working subnet within the corporate network. Thus structured, the system allows the user to access network resources through the IP-phone device 10, while at the same time, providing such functions as LAN/internet security, data security, packet filtering, bandwidth management, traffic shaping (load balance), and virtual private network (VPN).

A slave program can be installed in the storage device 24. The slave program can receive commands from the remote control program or the browser of the corporate master computer to set up the IP-phone device 10, update the functional settings of all the units within the network control unit 30, upgrade the functions of each unit in the network control unit 30 or add new functions to the units. Besides, the slave program can be so designed as to be activated by voice or by key-in.

The aforesaid computer port 15 and network port 14 can be either one or a plurality of network port, cable port,RJ-11 modem port, AUX port, wireless network device, infrared port, serial port, parallel port, USB port, and IEEE 1394 port, and the computer devices B to be connected can be a personal computer, server, notebook PC, PDA, cell phone, or any other electronic or network devices; the network devices A to be connected can be a hub, router, NAT router, firewall, wireless network broadband router, ATU-modem, DSU modem, ISDN modem, cable modem, computer mainframe, switch, or any electronic or network devices.

Aside from filtering network data and monitoring network security, the aforesaid network security unit 31 can also perform such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting. Besides, the network security unit 31 can be designed with built-in 802.1X protocol to obtain authentication from authentication devices. Computers within an unauthenticated subnet may access network resources through this unit.

The aforesaid network management unit 32 can be so set up as to assign a specific transmission/reception bandwidth to each user or workgroup to avoid letting one particular user or workgroup take up too much bandwidth, affecting the effectiveness of the network. It can also be set up to assign an adequate bandwidth to a user according to his or her job functions, or allow a user to access internal or external networks only at specified time interval, so as to optimize the flow rate of the network. Furthermore, the network management unit 32 can also be set up the access rights of communication protocol control (TCP/IP, NETBUI, IPX, and APPLE TALK), communication ports, and network application software to each user or workgroup; and be set up the transmission/reception bandwidth to each user or workgroup according to the communication protocol control (TCP/IP, NETBUI, IPX, and APPLE TALK), communication ports, and network application software the user or workgroup uses.

The functions of the network security unit 31, the network management unit 32, and the VPN unit 33 in the network control unit 30 of the present invention can be performed by a single network security chip, a single network management chip, and a single VPN chip. The three single chips can be made into a single integrated chip or more than one chip each with one or two chips integrated into one. Also, any or all of the functions of the network security unit 31, network management unit 32, and VPN unit 33 in the network control unit 30 can be performed by the CPU 22. Furthermore, any or all of the units in the network control unit 30—the network security unit 31, network management unit 32, and the VPN unit 33—can be integrated with any or all of the component units in the core unit 20 of the IP-phone device10, with even the option of having all the two devices' component units integrated into one single chip. There is not much difference between the network control unit 30 being a single chip and being subordinated to the CPU 22 in terms of function and operation. Processing efficiency will be somewhat different. In the former case, the CPU 22 will have its full capacity given to the processing of other commands, such as the adding and redirection of packets that its efficiency will be better, but the end result will be the same as the later case.

One or some network application software also can be installed in the storage device 20 to enable the present invention providing network services such as WEB, DNS DDNS, DHCP, SMTP and FTP.

There is also one more thing to be noted: The multi-service IP-phone device of the present invention can be further integrated with a ATU-R modem, DSU modem, ISDN modem, or cable modem, so that its network port can be directed linked to an ADSL line, a Leased Line, or ISDN line, or cable.

The network security unit 31, network management unit 32 and VPN unit 33 in the network control unit 30 of the multi-service IP-phone device of the present invention can all be removable inserted units that can be removed or inserted as necessary. Besides, the present invention may comprise an expandable insertion interface, which allows the user to insert other function units as necessary.

Each unit in the network control unit 30 of the present invention can be installed to conventional IP-phone device for adding function to or superseding existing functions of a conventional IP-phone device, so that the conventional IP-phone device may perform network security, network management, and VPN functions.

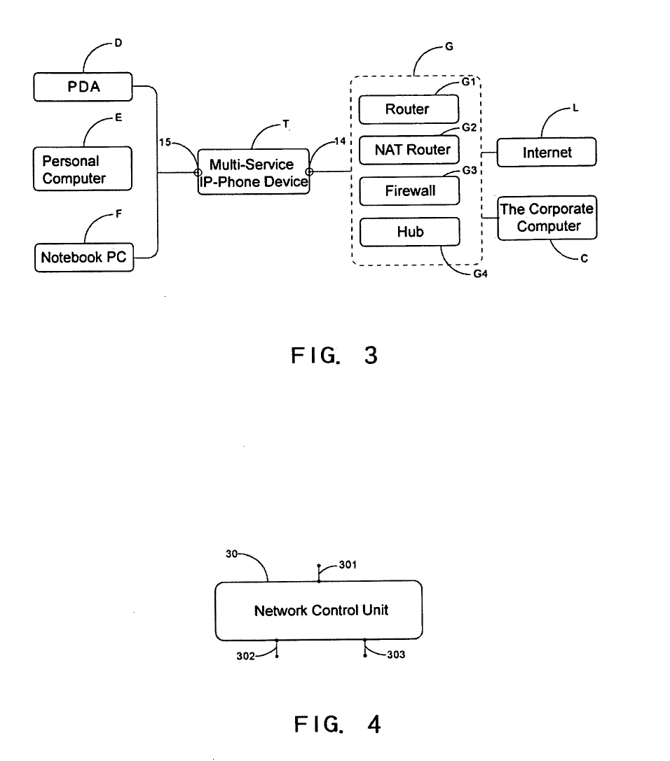

Please refer to FIG. 3. FIG. 3 is a diagram showing how the multi-service IP-phone device of the present invention works. As shown, the network port 14 of the multi-service IP-phone device of the present invention T is linked with the internet device G, wherein the internet device G may be a router G1, an NAT Router G2, a firewall G3, a hub G4. The computer device can be a PDA D, a personal computer E or a notebook PC F, can be connected with the multi-service IP-phone device T through the computer port 15. Thus, the multi-service IP-phone device of the present invention T can access corporate data of the corporate server C through the internet device G, or access external networks through the Internet L.

The internet device G mentioned above may also be a wireless broadband router, an ATU-R modem, a DSU modem, a cable modem, a server or a switching device. The computer device used may also be a server, a cell phone, or any other electronic devices or network devices.

Aside from filtering network data and monitoring network security, the aforesaid network security unit 31 can also perform such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting. Besides, the network security unit 31 can be designed with built-in 802.1X protocol to obtain authentication from authentication devices. Computers within an unauthenticated subnet may access network resources through this unit.

With the structure as described above, not only the network security function, but the network control unit in the IP-phone device of the present invention can be designed with a built-in 802.1X standard to obtain authentication from authentication devices. This is to say that without going through the multi-service IP-phone device T or with the multi-service IP-phone device T failing to obtain authentication, computers will not be allowed to access the corporate server C or the internet L. The aim of the above is to protect corporate data security, making sure that, without the due process of obtaining permission, no computer devices (PDAs D, PERSONAL COMPUTER E, or notebook PC F) or any other electronic devices and network devices can either use the corporate network and access the data in the corporate server C, or obtain corporate data and pass them out through the internet. This is what may be termed “real network security”, and is a major feature and benefit the present invention aim to bring to the user.

Please refer to FIG. 4. FIG. 4 is a diagram showing the structure of the network control unit of the present invention. The pin 301of the network control unit 30 is controlled by the CPU. Pin 302 is connected with a computer port that can be connected to the computer device, while pin 303 is connected with a network port that can be connected to the internet device.

Conventional IP-phone devices generally fall into two categories: those with a switching unit and those with no switching unit. As the network control unit 30 of the present invention can perform the functions of a switching unit, it can be installed in these two types of IP-phone devices, to either supersede the switching unit of the conventional IP-phone device or add the switching unit to the conventional IP-phone device.

When the network control unit 30 of the multi-service IP-phone device of the present invention is installed in a conventional IP-phone device without a switching unit, the pin 301 of the network control unit 30 can be connected to the CPU in the conventional IP-phone device; the conventional IP-phone device will thus be upgraded to become an IP-phone device with a computer port, and the network control unit 30 will serve as a switching unit with network management capacity. When the network control unit 30 of the multi-service IP-phone device of the present invention is installed in a conventional IP-phone device with a switching unit, the user can either make the switching unit of the conventional IP-phone device obsolete and supersede it by the network control unit 30 of the multi-service IP-phone device of the present invention, or connect the network control unit 30 with the switching unit of the conventional IP-phone device serially, which is by connecting the pin 301 of the network control unit 30 with the pin where the switching units is connected with the computer port in the conventional IP-phone device (so that the network control unit 30 still can be controlled by the CPU through the original switching unit), and then connect the pin 302 to the computer port, and another pin 303 to the network port. The remaining pin of the original switching unit—the one originally connected to the network port—can remain idle or serve any other purpose (for example, be connected to another computer to serve as the monitoring end of network packets). Of course, there is more than one way to do the above serial connection. For instance, one can connect the pin 301 of the network control unit with the pin where the switching unit is originally connected with the network port, and keep idle the pin originally connected with the computer port or use it for any other purpose.

When the network control unit 30 of the present invention is added on the original IP-phone device, the network control unit, be it a single chip or just application software, can always be activated/driven by the CPU on the original IP-phone device.

Nevertheless, the number of pins on the network control unit 30 is not limited to three. For instance, as described in the above, the number of pins on the network control unit 30 can be just reduced to two, with either the pin connected to the computer port or the pin connected to the network port being provided by the original switching unit.

The main function of the present invention's network control unit is to perform general and advanced processing on network packets. The unit's position in the IP-phone device in relation to other devices or other units are not limited to those as given in the above description of the preferred embodiment.

One last point to state is that, what the multi-service IP-phone device and method of the present invention provide is not jut a multi-service IP-phone device, but also a multi-service IP-phone method and a network control unit that can be structured on any current IP-phone device to provide, in an internet-phone environment, such functions as LAN/internet security, data security, packet filtering, bandwidth management, traffic shaping (load balance), and virtual private network (VPN).

As is understood by a person skilled in the art, the foregoing preferred embodiment of the present invention is an illustration, rather than a limiting description, of the present invention. It is intended to cover various modifications and similar arrangements, for example, the types of the IP-phone device, the functions of any or all of the units in the network control unit, the number of units in the network control unit, types of the storage device (for instance, a hard disk instead), the position of each unit within the IP-phone device, the number of pins on the network control unit, IP-phone devices with SKYPE functions, as well as types of the computer ports and network ports etc.,—all the above may vary and should be considered within the spirit and scope of the appended claims of the present invention. In short, the spirit and scope should be accorded the broadest interpretation so as to encompass all such modifications and similar structures.

What is claimed:

1. A multi-service IP-phone device comprising:
an IP-phone device, used to access a network and receive and make intercom and inbound/outbound phone calls through a LAN or the Internet, on which there are network ports that can be connected to network devices and computer ports that can be connected to computer devices;
a core unit, built in said IP-phone device; wherein the core unit comprises a DSP, used to process signals, a CPU, used to execute commands from the IP-phone device and negotiate and control behaviors, a peripheral control unit, to receive commands from the CPU in order to control the peripherals, and a storage device, use to store data; and
a network control unit, built in the aforesaid IP-phone device, used to control network data transmission, wherein said network control unit comprises at least one of the following units:
a network security unit, used to filter data passing through the network and monitor its security;
a network management unit, used to assign, restrict, adjust, and monitor network bandwidth and flow rate;
a VPN unit, used to put encryption on data transmitted onto the internet;
and wherein, with above said design and structure, the user can, by linking said network port of said IP-phone device with said Network devices as well as said computer port of said IP-phone device with said computer devices, not only use said IP-phone device to receive and make phone calls, but also, through said network security unit in said network control unit, filter network data and monitor network security; and furthermore, said network security unit can be updated by a remote control program to upgrade its protection, filtering, and monitoring functions; said IP-phone device can also assign, restrict, adjust, and monitor network bandwidth and flow rate through said network management unit in said network control unit; and finally, by making use of said network control unit in said VPN unit, said IP-phone device allows said user, from outside the corporate and through the Internet, to access corporate resources on subnet within said corporate network, which all told, said system allows said user to access network resources through said IP-phone device, while at the same time, providing said user with such functions as LAN/internet security, data security, packet filtering, bandwidth management, traffic shaping (load balance), and virtual private network (VPN).

2. The multi-service IP-phone device as in claim 1, wherein on said IP-phone device are set such devices as:
Key buttons, which are for to dial phone numbers and key-in related setups;
a transceiver, which is for the user to make and receive phone calls; and
a screen display, for showing relevant operation messages;

3. The multi-service IP-phone device as in claim 1, wherein said core unit can further comprise a switching unit.

4. The multi-service IP-phone device as in claim 1, wherein the storage device of said core unit can be a memory or a hard disk.

5. The multi-service IP-phone device as in claim 1, wherein all the functions of said network security unit, said network management unit, and said VPN unit in said network control unit can be performed by a single network security chip, a single network management chip, and a single VPN chip, with the option of having the three single chips made into a single integrated chip, or into more than one chip each with one or two chips integrated into one.

6. The multi-service IP-phone device as in claim 1, wherein any or all the functions of said network security unit, said network management unit, and said VPN unit in said network control unit can be integrated with any or all of the component units in said core unit.

7. The multi-service IP-phone device as in claim 1, wherein any or all of the functions of said network security unit, said network management unit, and said VPN unit in said network control unit can be performed by said CPU.

8. The multi-service IP-phone device as in claim 1, wherein, aside from filtering network data and monitoring network security, said network security unit can also perform such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated subnet may access network resources through said unit.

9. The multi-service IP-phone device as in claim 5, wherein, aside from filtering network data and monitoring network security, said network security unit can also perform such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated subnet may access network resources through said unit.

10. The multi-service IP-phone device as in claim 6, wherein, aside from filtering network data and monitoring network security, said network security unit can also perform such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated subnet may access network resources through said unit.

11. The multi-service IP-phone device as in claim 7, wherein, aside from filtering network data and monitoring network security, said network security unit can also perform such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated subnet may access network resources through said unit.

12. The multi-service IP-phone device as in claim 1, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, so as to optimize the flow rate of the network.

13. The multi-service IP-phone device as in claim 5, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, so as to optimize the flow rate of the network.

14. The multi-service IP-phone device as in claim 6, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, so as to optimize the flow rate of the network.

15. The multi-service IP-phone device as in claim 7, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, so as to optimize the flow rate of the network.

16. The multi-service IP-phone device as in claim 1, wherein said network management unit can also be set up to assign transmission/reception bandwidth to each user or workgroup according to the communication protocol control, communication ports, and network application software the user or workgroup uses.

17. The multi-service IP-phone device as in claim 5, wherein said network management unit can also be set up to assign transmission/reception bandwidth to each user or workgroup according to the communication protocol control, communication ports, and network application software the user or workgroup uses.

18. The multi-service IP-phone device as in claim 6, wherein said network management unit can also be set up to assign transmission/reception bandwidth to each user or workgroup according to the communication protocol control, communication ports, and network application software the user or workgroup uses.

19. The multi-service IP-phone device as in claim 7, wherein said network management unit can also be set up to assign transmission/reception bandwidth to each user or workgroup according to the communication protocol control, communication ports, and network application software the user or workgroup uses.

20. The multi-service IP-phone device as in claim 1, wherein said network security unit, said network management unit and said VPN unit in said network control unit of said multi-service IP-phone device can all be removable inserted units that can be removed or inserted as necessary.

21. The multi-service IP-phone device as in claim 5, wherein said network security unit, said network management unit and said VPN unit in said network control unit of said multi-service IP-phone device can all be removable inserted units that can be removed or inserted as necessary.

22. The multi-service IP-phone device as in claim 6, wherein said network security unit, said network management unit and said VPN unit in said network control unit of said multi-service IP-phone device can all be removable inserted units that can be removed or inserted as necessary.

23. The multi-service IP-phone device as in claim 7, wherein said network security unit, said network management unit and said VPN unit in said network control unit of said multi-service IP-phone device can all be removable inserted units that can be removed or inserted as necessary.

24. The multi-service IP-phone device as in claim 1, wherein said device may further comprise an expandable insertion interface, which allows the user to insert other function units as necessary.

25. The multi-service IP-phone device as in claim 1, wherein a slave program can be installed in said storage device which said storage device able to communicate with said slave program through a remote control program or the browser of the corporate master computer in order to set up the IP-phone device, update the functional settings of all the units within the network control unit, upgrade the functions of each unit in the network control unit or add new functions to the units.

26. The multi-service IP-phone device as in claim 2, wherein a slave program can be installed in said storage device which said storage device able to communicate with said slave program through a remote control program or the browser of the corporate master computer in order to set up the IP-phone device, update the functional settings of all the units within the network control unit, upgrade the functions of each unit in the network control unit or add new functions to the units.

27. The multi-service IP-phone device as in claim 3, wherein a slave program can be installed in said storage device which said storage device able to communicate with said slave program through a remote control program or the browser of the corporate master computer in order to set up the IP-phone device, update the functional settings of all the units within the network control unit, upgrade the functions of each unit in the network control unit or add new functions to the units.

28. The multi-service IP-phone device as in claim 4, wherein a slave program can be installed in said storage device which said storage device able to communicate with said slave program through a remote control program or the browser of the corporate master computer in order to set up the IP-phone device, update the functional settings of all the units within the network control unit, upgrade the functions of each unit in the network control unit or add new functions to the units.

29. The multi-service IP-phone device as in claim 1, wherein a slave program can be installed in said storage device, said slave program can be activated by voice or by key-in in order to set up the functions of every unit in the network control unit.

30. The multi-service IP-phone device as in claim 2, wherein a slave program can be installed in said storage device, said slave program can be activated by voice or by key-in in order to set up the functions of every unit in the network control unit.

31. The multi-service IP-phone device as in claim 3, wherein a slave program can be installed in said storage device, said slave program can be activated by voice or by key-in in order to set up the functions of every unit in the network control unit.

32. The multi-service IP-phone device as in claim 4, wherein a slave program can be installed in said storage device, said slave program can be activated by voice or by key-in in order to set up the functions of every unit in the network control unit.

33. The multi-service IP-phone device as in claim 1, wherein one or some network application software is installed in said storage device to enable said storage device to provide any or all of network service such as WEB, DNS DDNS, DHCP, SMTP and FTP.

34. The multi-service IP-phone device as in claim 2, wherein one or some network application software is installed in said storage device to enable said storage device to provide any or all of network service such as WEB, DNS DDNS, DHCP, SMTP and FTP.

35. The multi-service IP-phone device as in claim 3, wherein one or some network application software is installed in said storage device to enable said storage device to provide any or all of network service such as WEB, DNS DDNS, DHCP, SMTP and FTP.

36. The multi-service IP-phone device as in claim 4, wherein one or some network application software is installed in said storage device to enable said storage device to provide any or all of network service such as WEB, DNS DDNS, DHCP, SMTP and FTP.

37. The multi-service IP-phone device as in claim 1, wherein said IP-phone device can also be with SKYPE functions.

38. The multi-service IP-phone device as in claim 1, wherein any or all of the functions of said network security unit, said network management unit, and said VPN unit in said network control unit can be performed by said CPU.

39. The multi-service IP-phone device as in claim 1, wherein said computer port and network port can be either one or a plurality of network port, cable port, RJ-11 modem port, AUX port, wireless network device, infrared port, serial port, parallel port, USB port, and IEEE 1394 port, and the computer devices to be connected can be a personal computer, server, notebook PC, PDA, cell phone, or any other electronic or network devices.

40. The multi-service IP-phone device as in claim 1, wherein said computer port and network port can be either one or a plurality of network port, cable port, RJ-11 modem port, AUX port, wireless network device, infrared port, serial port, parallel port, USB port, and IEEE 1394 port, and said network devices to be connected can be a hub, router, NAT Router, firewall, wireless network broadband router, ATU-modem, DSU modem, ISDN modem, cable modem, computer mainframe, switch, or any electronic or network devices.

41. The multi-service IP-phone device as in claim 1, wherein said device can be further integrated with an ATU-R modem, DSU modem, ISDN modem, or cable modem, so that its network port can be directed linked to an ADSL line, a Leased Line, or ISDN line, or a cable.

42. The multi-service IP-phone device as in claim 5, wherein said device can be further integrated with an ATU-R modem, DSU modem, ISDN modem, or cable modem, so that its network port can be directed linked to an ADSL line, a Leased Line, or ISDN line, or a cable.

43. The multi-service IP-phone device as in claim 6, wherein said device can be further integrated with an ATU-R modem, DSU modem, ISDN modem, or cable modem, so that its network port can be directed linked to an ADSL line, a Leased Line, or ISDN line, or a cable.

44. The multi-service IP-phone device as in claim 7, wherein said device can be further integrated with an ATU-R modem, DSU modem, ISDN modem, or cable modem, so that its network port can be directed linked to an ADSL line, a Leased Line, or ISDN line, or a cable.

45. A network control unit for IP-phone devices, built in the IP-phone device, used to control network data transmission, comprises at least one of the following units:
a network security unit, used to filter data passing through the network and monitor its security;
a network management unit, used to assign, restrict, adjust, and monitor network bandwidth and flow rate;
a VPN unit, used to put encryption on data transmitted onto the internet;
and wherein, with above said design and structure, the user can not only use said IP-phone device to receive and make phone calls, but also, through said network security unit in said network control unit, filter network data and monitor network security; and furthermore, said network security unit can be updated by a remote control program to upgrade its protection, filtering, and monitoring functions; said IP-phone device can also assign, restrict, adjust, and monitor network bandwidth and flow rate through said network management unit in said network control unit; and finally, by making use of said network control unit in said VPN unit, said IP-phone device allows said user, from outside the corporate and through the Internet, to access corporate resources on subnet within said corporate network, which all told, said system allows said user to access network resources through said IP-phone device, while at the same time, providing said user with such functions as LAN/internet security, data security, packet filtering, bandwidth management, traffic shaping (load balance), and virtual private network (VPN).

46. A network control unit for IP-phone devices as in claim 44, wherein all the functions of said network security unit, said network management unit, and said VPN unit in said network control unit can be performed by a single network security chip, a single network management chip, and a single VPN chip, with the option of having the three single chips made into a single integrated chip, or into more than one chip each with one or two chips integrated into one.

47. A network control unit for IP-phone devices as in claim 44, wherein any or all the functions of said network security unit, said network management unit, and said VPN unit in said network control unit can be integrated with any or all of the component units in IP-phone devices.

48. A network control unit for IP-phone devices as in claim 44, wherein any or all of the functions of said network security unit, said network management unit, and said VPN unit in said network control unit can be performed by said CPU.

49. A network control unit for IP-phone devices as in claim 44, wherein, aside from filtering network data and monitoring network security, said network security unit can also perform any or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also said network security unit can be designed with built-in 802.1X protocol to obtain authentication from authentication devices and computers within an unauthenticated subnet may access network resources through said unit.

50. A network control unit for IP-phone devices as in claim 45, wherein, aside from filtering network data and monitoring network security, said network security unit can also perform any or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also said network security unit can be designed with built-in 802.1X protocol to obtain authentication from authentication devices and computers within an unauthenticated subnet may access network resources through said unit.

51. A network control unit for IP-phone devices as in claim 46, wherein, aside from filtering network data and monitoring network security, said network security unit can also perform any or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also said network security unit can be designed with built-in 802.1X protocol to obtain authentication from authentication devices and computers within an unauthenticated subnet may access network resources through said unit.

52. A network control unit for IP-phone devices as in claim 47, wherein, aside from filtering network data and monitoring network security, said network security unit can also perform any or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also said network security unit can be designed with built-in 802.1X protocol to obtain authentication from authentication devices and computers within an unauthenticated subnet may access network resources through said unit.

53. A network control unit for IP-phone devices as in claim 44, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

54. A network control unit for IP-phone devices as in claim 45, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

55. A network control unit for IP-phone devices as in claim 46, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

56. A network control unit for IP-phone devices as in claim 47, wherein, said network management unit can be so set up as to assign a specific transmission/reception bandwidth to each user or workgroup to avoid letting one particular user or workgroup take up too much bandwidth, affecting the effectiveness of the network; it can also be set up to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

57. A network control unit for IP-phone devices as in claim 44, wherein the user can make use of a remote control program or the browser to set up the units within the network control unit, update the functional settings of all the units within the network control unit, upgrade the functions of each unit in the network control unit or add new functions to the units.

58. A network control unit for IP-phone devices as in claim 45, wherein the user can make use of a remote control program or the browser to set up the units within the network control unit, update the functional settings of all the units within the network control unit, upgrade the functions of each unit in the network control unit or add new functions to the units.

59. A network control unit for IP-phone devices as in claim 46, wherein the user can make use of a remote control program or the browser to set up the units within the network control unit, update the functional settings of all the units within the network control unit, upgrade the functions of each unit in the network control unit or add new functions to the units.

60. A network control unit for IP-phone devices as in claim 47, wherein the user can make use of a remote control program or the browser to set up the units within the network control unit, update the functional settings of all the units within the network control unit, upgrade the functions of each unit in the network control unit or add new functions to the units.

61. A network control unit for IP-phone devices as in claim 44, wherein the functions of every unit in the network control unit can be set up by voice or by key-in.

62. A network control unit for IP-phone devices as in claim 45, wherein the functions of every unit in the network control unit can be set up by voice or by key-in.

63. A network control unit for IP-phone devices as in claim 46, wherein the functions of every unit in the network control unit can be set up by voice or by key-in.

64. A network control unit for IP-phone devices as in claim 47, wherein the functions of every unit in the network control unit can be set up by voice or by key-in.

65. A network control unit for IP-phone devices as in claim 44, wherein said network control unit can further provide any or all of such services as WEB, DNS DDNS, DHCP, SMTP and FTP.

66. A network control unit for IP-phone devices as in claim 45, wherein said network control unit can further provide any or all of such services as WEB, DNS DDNS, DHCP, SMTP and FTP.

67. A network control unit for IP-phone devices as in claim 46, wherein said network control unit can further provide any or all of such services as WEB, DNS DDNS, DHCP, SMTP and FTP.

68. A network control unit for IP-phone devices as in claim 47, wherein said network control unit can further provide any or all of such services as WEB, DNS DDNS, DHCP, SMTP and FTP.

69. A network control unit for IP-phone devices as in claim 44, wherein said network control unit can be further integrated with an ATU-R modem, DSU modem, ISDN modem, or cable modem, so that its network port can be directed linked to an ADSL line, a Leased Line, or ISDN line, or a cable.

70. A network control unit for IP-phone devices as in claim 45, wherein said network control unit can be further integrated with an ATU-R modem, DSU modem, ISDN modem, or cable modem, so that its network port can be directed linked to an ADSL line, a Leased Line, or ISDN line, or a cable.

71. A network control unit for IP-phone devices as in claim 46, wherein said network control unit can be further integrated with an ATU-R modem, DSU modem, ISDN modem, or cable modem, so that its network port can be directed linked to an ADSL line, a Leased Line, or ISDN line, or a cable.

72. A network control unit for IP-phone devices as in claim 47, wherein said network control unit can be further integrated with an ATU-R modem, DSU modem, ISDN modem, or cable modem, so that its network port can be directed linked to an ADSL line, a Leased Line, or ISDN line, or a cable.

73. A network control unit for IP-phone devices as in claim 44, wherein said network security unit, said network management unit and said VPN unit in the network control unit of said network control unit can all be removable inserted units that can be removed or inserted as necessary.

74. A network control unit for IP-phone devices as in claim 45, wherein said network security unit, said network management unit and said VPN unit in the network control unit of said network control unit can all be removable inserted units that can be removed or inserted as necessary.

75. A network control unit for IP-phone devices as in claim 46, wherein said network security unit, said network management unit and said VPN unit in the network control unit of said network control unit can all be removable inserted units that can be removed or inserted as necessary.

76. A network control unit for IP-phone devices as in claim 47, wherein said network security unit, said network management unit and said VPN unit in the network control unit of said network control unit can all be removable inserted units that can be removed or inserted as necessary.

77. A network control unit for IP-phone devices as in claim 44, wherein said network control unit may further comprise an expandable insertion interface, which allows the user to insert other function units as necessary.

78. A network control unit for IP-phone devices as in claim 45, wherein said network control unit may further comprise an expandable insertion interface, which allows the user to insert other function units as necessary.

79. A network control unit for IP-phone devices as in claim 46, wherein said network control unit may further comprise an expandable insertion interface, which allows the user to insert other function units as necessary.

80. A network control unit for IP-phone devices as in claim 47, wherein said network control unit may further comprise an expandable insertion interface, which allows the user to insert other function units as necessary.

81. A multi-service IP-phone method which implements network control structure on an IP-phone device; said method comprises:
an IP-phone device; and
a network control unit, built in the said IP-phone device, used to control network data transmission, wherein said network control unit comprises at least one of the following units:
a network security unit, used to filter data passing through the network and monitor its security;
a network management unit, used to assign, restrict, adjust, and monitor network bandwidth and flow rate;
a VPN unit, used to put encryption on data transmitted onto the internet;
and wherein, with above said design and structure, the user can not only use said IP-phone device to receive and make phone calls, but also, through said network security unit in said network control unit, filter network data and monitor network security; and furthermore, said network security unit can be updated by a remote control program to upgrade its protection, filtering, and monitoring functions; said IP-phone device can also assign, restrict, adjust, and monitor network bandwidth and flow rate through said network management unit in said network control unit; and finally, by making use of said network control unit in said VPN unit, said IP-phone device allows said user, from outside the corporate and through the Internet, to access corporate resources on subnet within said corporate network, which all told, said system allows said user to access network resources through said IP-phone device, while at the same time, providing said user with such functions as LAN/internet security, data security, packet filtering, bandwidth management, traffic shaping (load balance), and virtual private network (VPN).

82. A multi-service IP-phone method as in claim 80, wherein all the functions of said network security unit, said network management unit, and said VPN unit in said network control unit can be performed by a single network security chip, a single network management chip, and a single VPN chip, with the option of having the three single chips made into a single integrated chip, or into more than one chip each with one or two chips integrated into one.

83. A multi-service IP-phone method as in claim 80, wherein any or all the functions of said network security unit, said network management unit, and said VPN unit in said network control unit can be integrated with any or all of the component units in IP-phone devices.

84. A multi-service IP-phone method as in claim 80, wherein any or all of the functions of said network security unit, said network management unit, and said VPN unit in said network control unit can be performed by said CPU.

85. A multi-service IP-phone method as in claim 80, wherein, aside from filtering network data and monitoring network security, said network security unit can also perform one or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated domain may access network resources through said unit.

86. A multi-service IP-phone method as in claim 81, wherein, aside from filtering network data and monitoring network security, said network security unit can also perform one or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated domain may access network resources through said unit.

87. A multi-service IP-phone method as in claim 82, wherein, aside from filtering network data and monitoring network security, said network security unit can also perform one or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated domain may access network resources through said unit.

88. A multi-service IP-phone method as in claim 83, wherein, aside from filtering network data and monitoring network security, said network security unit can also perform one or all of such functions as ACL, anti-virus, anti-hacking, anti-DoS/DdoS attack, anti-website-attack, security level setting, anti-spam, file security control, network application access control, communication protocol control, intrusion detection and prevention, data transmission record, network application access record, and port-specific intercom and inbound/outbound security policy setting; also, said network security unit can be designed with built-in 802.1X protocol to obtain authentication from authentication devices and computers within an unauthenticated domain may access network resources through said unit.

89. A multi-service IP-phone method as in claim 80, wherein, said network management unit can be so set up as to assign a specific transmission/reception bandwidth to each user or workgroup, or so set up as to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

90. A multi-service IP-phone method as in claim 81, wherein, said network management unit can be so set up as to assign a specific transmission/reception bandwidth to each user or workgroup, or so set up as to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

91. A multi-service IP-phone method as in claim 82, wherein, said network management unit can be so set up as to assign a specific transmission/reception bandwidth to each user or workgroup, or so set up as to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

92. A multi-service IP-phone method as in claim 83, wherein, said network management unit can be so set up as to assign a specific transmission/reception bandwidth to each user or workgroup, or so set up as to assign an adequate bandwidth to a user according to his or her job functions, or allow a user to access internal or external networks only at specified time interval, or even so set up as to assign transmission/reception bandwidth to each user or workgroup according to the communication protocol control, communication ports, and network application software the user or workgroup uses.

93. A multi-service IP-phone method as in claim 80, wherein the user can make use of a remote control program or the browser of the corporate master computer to set up the IP-phone device, update the functional settings of all the units within the network control unit, upgrade the functions of each unit in the network control unit or add new functions to the units.

94. A multi-service IP-phone method as in claim 81, wherein the user can make use of a remote control program or the browser of the corporate master computer to set up the IP-phone device, update the functional settings of all the units within the network control unit, upgrade the functions of each unit in the network control unit or add new functions to the units.

95. A multi-service IP-phone method as in claim 82, wherein the user can make use of a remote control program or the browser of the corporate master computer to set up the IP-phone device, update the functional settings of all the units within the network control unit, upgrade the functions of each unit in the network control unit or add new functions to the units.

96. A multi-service IP-phone method as in claim 83, wherein the user can make use of a remote control program or the browser of the corporate master computer to set up the IP-phone device, update the functional settings of all the units within the network control unit, upgrade the functions of each unit in the network control unit or add new functions to the units.

97. A multi-service IP-phone method as in claim 80, wherein the functions of every unit in the network control unit can be set up by voice or by key-in.

98. A multi-service IP-phone method as in claim 81, wherein the functions of every unit in the network control unit can be set up by voice or by key-in.

99. A multi-service IP-phone method as in claim 82, wherein the functions of every unit in the network control unit can be set up by voice or by key-in.

100. A multi-service IP-phone method as in claim 83, wherein the functions of every unit in the network control unit can be set up by voice or by key-in.

101. A multi-service IP-phone method as in claim 80, wherein said network control unit can further provide one or all of such services as WEB, DNS DDNS, DHCP, SMTP and FTP.

102. A multi-service IP-phone method as in claim 81, wherein said network control unit can further provide one or all of such services as WEB, DNS DDNS, DHCP, SMTP and FTP.

103. A multi-service IP-phone method as in claim 82, wherein said network control unit can further provide one or all of such services as WEB, DNS DDNS, DHCP, SMTP and FTP.

104. A multi-service IP-phone method as in claim 83, wherein said network control unit can further provide one or all of such services as WEB, DNS DDNS, DHCP, SMTP and FTP.

105. A multi-service IP-phone method as in claim 80, wherein said network control unit can be further integrated with an ATU-R modem, DSU modem, ISDN modem, or cable modem, so that its network port can be directed linked to an ADSL line, a Leased Line, or ISDN line, or a cable.

106. A multi-service IP-phone method as in claim 81, wherein said network control unit can be further integrated with an ATU-R modem, DSU modem, ISDN modem, or cable modem, so that its network port can be directed linked to an ADSL line, a Leased Line, or ISDN line, or a cable.

107. A multi-service IP-phone method as in claim 82, wherein said network control unit can be further integrated with an ATU-R modem, DSU modem, ISDN modem, or cable modem, so that its network port can be directed linked to an ADSL line, a Leased Line, or ISDN line, or a cable.

108. A multi-service IP-phone method as in claim 83, wherein said network control unit can be further integrated with an ATU-R modem, DSU modem, ISDN modem, or cable modem, so that its network port can be directed linked to an ADSL line, a Leased Line, or ISDN line, or a cable.

109. A multi-service IP-phone method as in claim 80, wherein said network security unit, said network management unit and said VPN unit in the network control unit of said network control unit can all be removable inserted units that can be removed or inserted as necessary.

110. A multi-service IP-phone method as in claim 81, wherein said network security unit, said network management unit and said VPN unit in the network control unit of said network control unit can all be removable inserted units that can be removed or inserted as necessary.

111. A multi-service IP-phone method as in claim 82, wherein said network security unit, said network management unit and said VPN unit in the network control unit of said network control unit can all be removable inserted units that can be removed or inserted as necessary.

112. A multi-service IP-phone method as in claim 83, wherein said network security unit, said network management unit and said VPN unit in the network control unit of said network control unit can all be removable inserted units that can be removed or inserted as necessary.

113. A multi-service IP-phone method as in claim 80, wherein said network control unit may further comprise an expandable insertion interface, which allows the user to insert other function units as necessary.

114. A multi-service IP-phone method as in claim 81, wherein said network control unit may further comprise an expandable insertion interface, which allows the user to insert other function units as necessary.

115. A multi-service IP-phone method as in claim 82, wherein said network control unit may further comprise an expandable insertion interface, which allows the user to insert other function units as necessary.

116. A multi-service IP-phone method as in claim 83, wherein said network control unit may further comprise an expandable insertion interface, which allows the user to insert other function units as necessary.
